(19) United States
(12) Patent Application Publication
(10) Pub. No.: US 2013/0015766 A1
(43) Pub. Date: Jan. 17, 2013

(54) APPARATUS FOR GENERATING MINI AND MICRO PLASMAS AND METHODS OF USE

(71) Applicants: Mazdak TAGHIOSKOUI, Olney, MD (US); Mona ZAGHLOUL, Bethesda, MD (US)

(72) Inventors: Mazdak TAGHIOSKOUI, Olney, MD (US); Mona ZAGHLOUL, Bethesda, MD (US)

(73) Assignee: The George Washington University, Washington, DC (US)

(21) Appl. No.: 13/469,716

(22) Filed: May 11, 2012

Related U.S. Application Data
(60) Provisional application No. 61/485,469, filed on May 12, 2011.

(51) Int. Cl. H05H 1/50

(52) U.S. Cl. 315/111.41

(57) ABSTRACT

Systems and methods for formation of an ultra high frequency atmospheric pressure plasma jet are presented. A magnetic loop has first and second ends and a gap for generating the plasmas. An inner arc provides RF power to the magnetic loop. Use of the described structure allows for generation of plasmas in air and in inert gases such as argon and helium. Various properties, including the non-thermal nature and shape of the plasma jet are discussed. Applications for utilizing the non-thermal plasma jet are provided.

### CROSS-REFERENCE TO RELATED APPLICATIONS

This application claims the benefit under 35 U.S.C. §119(e) of U.S. Provisional Patent Application No. 61/485,469, filed May 12, 2011, the disclosure of which is hereby incorporated herein by reference in its entirety.

### BACKGROUND OF THE INVENTION

Atmospheric pressure plasmas are gaining growing interest due to their efficacy in diverse fields such as nanoparticle generation, surface treatment, biomedical applications, and chemical analysis. In treatment of vulnerable biological materials including membranes and skin, plasma sources must offer stringent provisions such as no risk of arcing and operation at near room temperature to prevent painful sensation or heating of delicate targets. Plasma jets generated using pulsed direct current (DC) power supplies are often operated at high voltage, raising concerns about increased risk of electrical shock during treatment. One approach to address this problem is the use of radio frequency (RF) power to form a small, spot-sized plasma at the tip of a metallic needle. While RF plasmas provide higher densities of active species compared to DC plasmas, their medical applications are limited by their generally higher temperatures and short plasma lengths.

Applications of micro plasma sources in diverse equipment or devices such as plasma-based chemical analyzers are known in the art. S. Weagant and V. Karanassios, Anal. Bioanal. Chem. 395, 577 (2009); J. Hopwood, F. Iza, S. Coy and D. B. Fenner, J. Phys. D: Appl. Phys. 38, 1698 (2005). One such application of micro plasma sources is in biomedical and dental sterilizers. F. Iza, G. J. Kim, S. M. Lee, J. K. Lee, J. L. Walsh, Y. T. Zhang, M. G. Kong, Plasma Process. Polym. 5, 322 (2008); R. E. J. Sladek, E. Stoffels, R. Walraven, P. J. A. Tielbeek, and R. A. Koolhoven, IEEE Trans. Plasma Sci. 32, 1540 (2004). However, the development of portable micro plasma devices is a major challenge because power consumption, plasma gas type, and operating pressure are three major parameters that must be optimized for developing portable micro plasmas.

Thus, use of air as the plasma gas at atmospheric pressure is important to eliminate the requirement of noble gas, vacuum pump, and related auxiliary components. Further, reduction of the power consumption extends the operation period and utilization of battery-based devices. The required power for sustaining the plasma is reduced by pulse modulation (PM) of ultra high frequency (UHF) plasmas. Y. Shimizu, K. Kawaguchi, T. Sasaki, and N. Koshizaki, Appl. Phys. Lett. 94, 191504 (2009); J. J. Shi, J. Zhang, G. Qiu, J. L. Walsh, and M. G. Kong, Appl. Phys. Lett. 93, 041502 (2008); N. Balcon, A. Aanesland, and R. Boswell, Plasma Sources Sci. Technol. 16, 217 (2007); R. Ye, T. Ishigaki, and T. Sakuta, Plasma Sources Sci. Technol. 14, 387 (2005). UHF designates the range of electromagnetic waves between 300 MHz and 3,000 MHz. Microwave designates frequencies between 300 MHz and 300 GHz.

Non-thermal plasmas consist of high-energy electrons, positively and negatively charged ions, and metastable species at ambient temperature. These plasmas are formed by ionization and excitation of atoms or molecules as a result of collision with high-energy electrons. The electron temperature is usually much higher than ion and gas temperatures in non-thermal plasmas, making them attractive sources for applications such as surface modification, sterilization, and wound healing at room temperature.

Accordingly, a need exists for the generation of a stable atmospheric pressure air micro plasma (APAMP), operating in the microwave range and under ambient condition. A further need exists for the generation of micro plasma in inert gases such as argon, nitrogen and helium.

### BRIEF SUMMARY OF THE INVENTION

In an embodiment of the present invention, an apparatus for generating a non-thermal, ultra-high frequency plasma at atmospheric pressure is presented. The apparatus comprises a magnetic loop having a first end, a second end and a gap of a predetermined width between the first and second ends, the magnetic loop generating the non-thermal, ultra-high frequency plasma at atmosphere pressure in the gap of the magnetic loop. An inner arc is connected to the magnetic loop. A connector is provided for supplying the magnetic loop with electrical power in the UHF range. In an alternate embodiment, the first end and the second end of the magnetic loop are positioned within a tube for directing the flow of gas to the first and second ends to form a plasma jet.

In another embodiment of the present invention, a method of generating a non-thermal ultra-high frequency plasma at atmospheric pressure is presented. The method comprises receiving an amplified UHF signal by a magnetic loop, the magnetic loop comprising a conductor having a first end, a second end and a gap between the first and second ends and an inner arc. The method generating the non-thermal, ultra-high frequency plasma at atmospheric pressure in the gap of the magnetic loop. In an alternate embodiment, the first end and the second end are positioned in a tube for directing gas flow to the first end and second end for plasma formation and an inert gas is supplied through the tube.

In yet another embodiment, an atmospheric pressure air microplasma (APAMP) source is presented that operates under ambient conditions using a magnetic loop device at an operating frequency of about 740 MHz. Preferably, the magnetic loop device is a magnetic loop antenna. A self-igniting, stable APAMP was generated at about 9.5 Watts. Pulse modulation (PM) was applied to the UHF signal. The effects of PM on self-ignition and operation of the APAMP source were studied by using a square wave modulating signal in the frequency range of about 5 KHz to about 30 KHz. With the application of PM on the APAMP, in the best case, the plasma self-ignites and is sustained at about 2.5 Watts.

In another embodiment, an argon plasma was formed in the magnetic loop device using a tube to direct gas flow at the carrier and modulation frequency of about 850 MHz and about 60 KHz, respectively. The plasma exhibited a non-thermal nature at about 4.2 Watts, and may be touched by human finger.

The primary applications of this device include synthesis of new compounds and materials and in surface treatment of materials and thermally sensitive biomedical targets. The aim of the treatment can be modifying surface structure or sterilization. However, this device can also be utilized as a source of ions, electrons, and photons in chemical analysis. The ions and photons produced by the plasma(s) generated in this device may be used in mass spectrometry, ambient spectrometry or optical spectroscopy to develop, for example, fieldable sensor platforms for non-invasive breath monitoring, environmental studies in workplace and public locations for the detection of hazardous gases, and for the detection of chemical vapors, such as benzene, a known human carcinogen.

Thus, non-thermal atmospheric pressure air plasma jet and argon plasma jet operated at UHF range are presented to resolve the limitations of the current DC and RF plasma devices.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

The foregoing summary and the following detailed description of a preferred embodiment of the invention, will be better understood when read in conjunction with the appended drawings. For the purpose of illustrating the preferred adaptable ornamental wire frame model, there is shown in the drawings embodiments which are presently preferred. It should be understood, however, that the invention is not limited to the precise arrangements and instrumentalities shown.

FIG. 1 includes, from the top, a perspective view, front view and side view of a preferred embodiment of the magnetic loop arrangement for micro plasma generation;

FIG. 2 is a depiction showing a front view of the magnetic loop device generating plasma in air at the gap of the magnetic loop;

FIG. 3 illustrates a magnetic loop device having two electrodes residing within a tube for directing the flow of gas;

FIG. 4 is a graph of the effect of magnetic loop radius on reflection parameter and resonance frequency of the magnetic loop;

FIG. 5 is a graph of the effect of magnetic loop gap width on reflection parameter and resonance frequency of magnetic loop;

FIG. 6 is a graph of the effect of wire thickness on reflection parameter and resonance frequency of the magnetic loop;

FIGS. 7(a) and 7(b) illustrate a schematic of the setup for generation of micro plasma using a magnetic loop device and micro plasmas generated in air under ambient condition using the magnetic loop operating at a frequency of about 740 MHz;

FIG. 8 is a graph presenting the waveform of a 20 KHz modulated signal at the minimum power required for self-ignition of the APAMP;

FIGS. 9(a) and 9(b) are graphs plotting the self-ignition power vs pulse amplitude and the difference in required power value vs pulse amplitude for modulation frequencies of 5 KHz, 10 KHz, 20 KHz, and 30 KHz;

FIG. 10 shows the optical emission spectrum of the modulated APAMP at about 9.5 watts;

FIG. 11 is a schematic diagram of an experimental setup as used in mass spectrometry and emission spectrometry using an embodiment of the plasma jet generator of the invention;

FIGS. 12(a), 12(b) and 12(c) illustrate an embodiment of an experimental system including a schematic diagram for generation and mass spectrometric studies of atmospheric pressure argon plasma jet; the magnetic loop device and a depiction of plasma jet interaction with the sampling orifice of the mass spectrometer;

FIG. 13 shows the emission spectrum of the plasma jet;

FIG. 14 shows the typical mass spectrum, including protonated water clusters, ozone and hydrated ozone, of the background ions generated by the UHF plasma jet;

FIG. 15 shows the mass spectra of (a) benzene, (b) acetone, (c) propan-2-ol, (d) acetic acid, and (e) acetonitrile vapor in air detected using the apparatus of the invention;

FIGS. 16(a), 16(b) and 16(c) demonstrate an atmospheric pressure argon tongue-shaped plasma jet operating at the carrier and modulation frequency; a side view of the plasma jet and the non-thermal properties of the plasma jet;

FIG. 17 shows a waveform of the signal, (a) from the signal generator, (b) radiated from the magnetic loop without plasma, and (c) radiated from the magnetic loop with plasma;

FIG. 18 is a graph of the power consumption of a plasma jet formed in a magnetic loop device;

FIG. 19 includes depictions of plasma jet configurations as observed with a charge coupled detector (CCD) for exposure times of 100, 500, 1000 μs;

FIG. 20 includes depictions of the plasma jet shape as the function modulation frequency with camera exposure time of 5 ms;

FIG. 21 is a graph of the length of plasma jet as a function of the modulation frequency;

FIG. 22 are the mass spectra of argon plasma jet acquired at (a) low sampling flow with interface pressure of 2 Torr, and (b) high sampling flow with interface pressure of 10 Torr;

FIG. 23 shows the optical emission spectrum of plasma jet from 300 to 760 nm;

FIG. 24 shows the spatial emission intensities of argon and nitrogen at 697 and 337 nm, respectively;

FIGS. 25(a), 25(b), 25(c) and 25(d) are depictions showing onion cells before plasma treatment, (b) a drop of water on onion membrane placed on water-coated glass slide, exhibiting hydrophobic behavior before plasma treatment, (c) onion membrane after treatment with plasma jet for 1 minute, and (d) drop of water on the onion membrane after treatment with plasma for 1 minute; and

FIG. 26 is a graph of the ratio of radiated power with plasma and without plasma as a function of modulation frequency for plasma formed with the magnetic loop.

### DETAILED DESCRIPTION OF THE INVENTION

Certain terminology is used in the following description for convenience only and is not limiting. The words “right,” “left,” “upper,” and “lower” designate directions in the drawings to which reference is made. The terminology includes the words specifically mentioned above, derivatives thereof, and words of similar import.

Though the following discussion is made with reference to frequencies in the ultra-high frequency (UHF) range, it should be understood that the scope of the invention is not so limited and that plasmas generated in any frequency in the microwave range are within the scope of this disclosure.

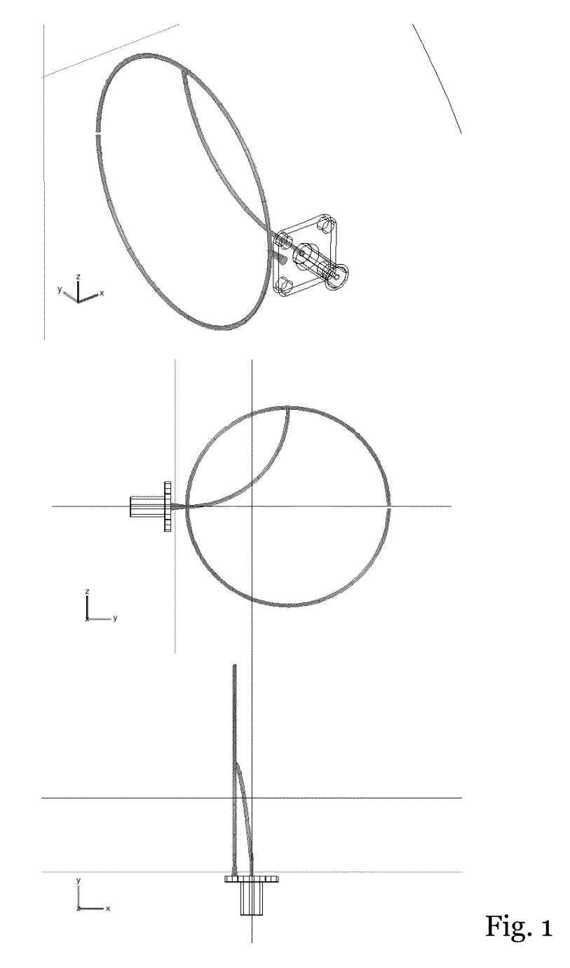

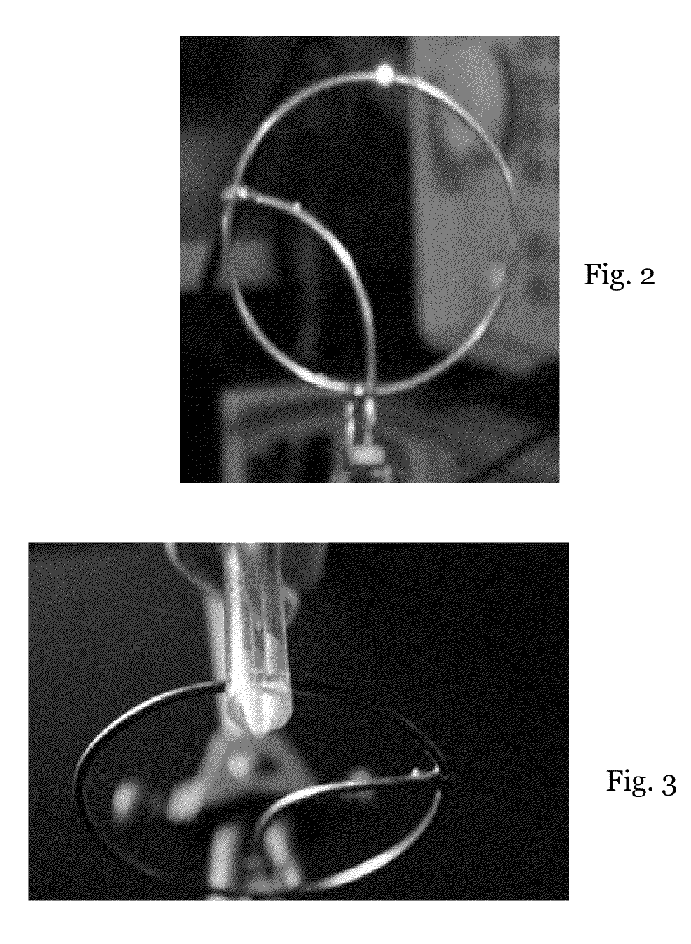

In preferred embodiments of this invention, a magnetic loop is constructed from tin-coated copper wire. Referring to FIG. 1, a perspective view, front view and side view of the magnetic loop arrangement are shown. Preferably, the magnetic loop has a diameter of about 5 cm and a gap of the order of about 100 micro meters where the micro plasma may form. Referring to FIG. 2, in a first embodiment, air is used as the gas from which plasma is generated in the gap of the magnetic loop. Referring to FIG. 3, in other embodiments, the plasma is generated in inert gases such as argon, nitrogen or helium by placing the electrodes and the gap of the magnetic loop in a tube used to direct the plasma gas flow. The tube may preferably be made of a glass or plastic material, but the material does not affect the operation of the device because its purpose is to provide gas flow direction.

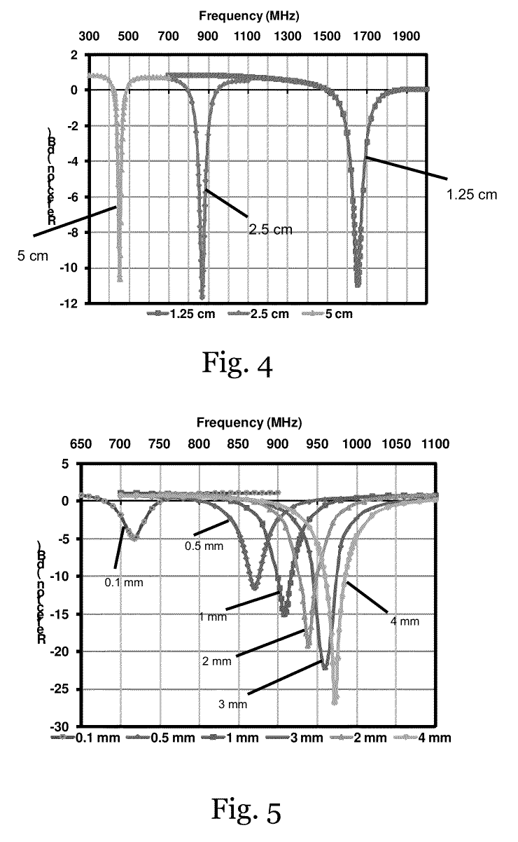

Referring to FIG. 4, effects of magnetic loop radius on the reflection parameter and resonance frequency of the magnetic loop are shown for radii of 1.25 cm, 2.5 cm and 5 cm. An increase in the magnetic loop radius shifts the resonance frequency of the magnetic loop to higher values. Thus the resonance frequency for a magnetic loop with radius of 1.25 cm is approximately 450 MHz, while the resonance frequency for the magnetic loop with radius of 5 cm is at approximately 1650 MHz. However, the efficiency of the magnetic loop is independent of the loop radius.

Referring to FIG. 5, effects of magnetic loop gap width on the reflection parameter and resonance frequency of the magnetic loop are shown. The resonance frequency and efficiency are plotted for gap widths ranging from 0.1 mm to 4 mm. As can be seen in FIG. 5, as the magnetic loop gap width increases, the resonance frequency of the magnetic loop increases for plasma generation.

The efficiency of the magnetic loop is enhanced by such a shift. For magnetic loop gap of 2.5 mm (not shown) the resonance frequency is about 960 MHz. The resonance frequency, during plasma jet operation, may be determined by sweeping the UHF signal frequency while monitoring the plasma jet power and optical emission intensity. At the frequency of approximately 850 MHz, maximum emission and minimum reflected power was observed at 1.5 Watts to 3 Watts. Formation of the plasma jet changes the overall impedance. As a result, the resonance frequency shifts by about −110 MHz due to plasma jet formation.

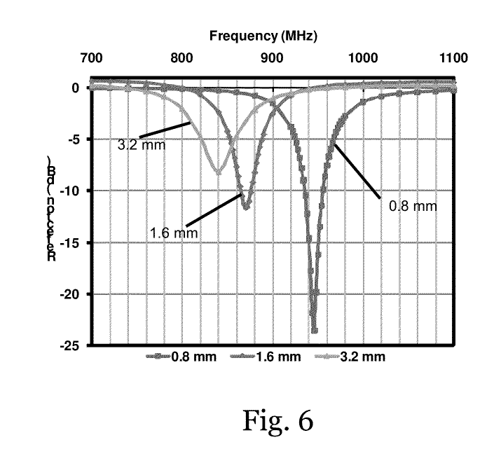

Referring now to FIG. 6, effects of wire thickness on reflection parameter and resonance frequency of the magnetic loop are shown for wires having a thickness of 0.8 mm, 1.6 mm and 3.2 mm. Increasing the thickness of the wire shifts the operating frequency of the plasma to higher values. The efficiency of the magnetic loop is enhanced by such a shift.

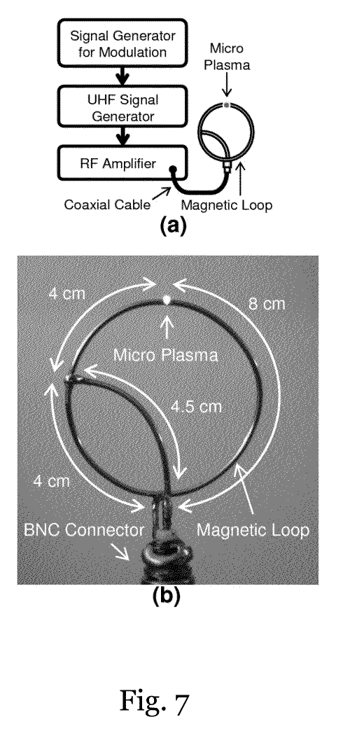

Referring to FIG. 7a, the magnetic loop is connected to a power amplifier using a coaxial cable and a sinusoidal UHF signal is generated and amplified using a signal generator and a linear amplifier, respectively. The inner arc of the magnetic loop provides RF power to the grounded loop. The location of the connection, where the inner wire is connected to the loop, along with the loop dimensions, defines the resonance frequency of the structure. This is because the loop acts as two inductors in parallel and the position of the inner wire connection defines the electrical properties of each inductor. The position of the inner arc within the magnetic loop can be changed to create several magnetic configurations for generating diverse plasmas.

Changing the position of the inner are can reduce the power requirement, facilitate plasma ignition by removing the need for a second plasma or modulation, and reduce reflected power. For example, different magnetic loop configurations can form other plasmas that are smaller in tip and diameter. These plasmas can have different lengths and may not require a matching network.

The resonance frequency shift for the magnetic loop is due to changes in the overall impedance of the circuit because of micro plasma formation.

The power output of the radio frequency (RF) amplifier may be monitored using an integrated RF power meter on the amplifier. The radiated RF signal from the magnetic loop may be monitored using a simple probe. A hand-held optical spectrometer may be used to monitor the optical emission from the APAMP.

### Generation of Plasma in Air

To study plasma formation in air, the reflection parameter of the magnetic loop may be observed at frequencies ranging from 300 MHz to 1000 MHz using an RF network analyzer. With no plasma, the resonance frequency of the magnetic loop occurred at 820 MHz. However, when the APAMP device was supplied with RF power at frequencies about 500 to about 1000 MHz, best performance of the APAMP based on the power consumption and emission intensity from micro plasma occurred at about 740 MHz. Thus, the resonance frequency was shifted after plasma formation by approximately −80 MHz. Referring to FIG. 7(b), the APAMP device is shown while in operation. At the frequency of about 740 MHz, the micro plasma self ignites at the forward and reflected power of about 9.5 Watts and about 4.2 Watts, respectively. The minimum forward and reflected power required for sustaining the micro plasma was about 3 Watts and about 0.25 Watts, respectively. However, reflected power may be reduced with a matching network, a dual stub tuner, or by changing the position of the inner arc.

To ignite UHF plasmas, power may be momentarily increased to produce adequate seed electrons for ignition as demonstrated by Yin. Y. Yin, J. Messier, and J. A. Hopwood, IEEE Trans. Plasma Sci. 27, 1516 (1999). Alternatively, as demonstrated by Kawajiri, a secondary plasma may be introduced to produce the initial seed electrons to reduce the ignition power required to form UHF plasmas. K. Kawajiri, T. Sato and H. Nishiyama, Surf. Coat. Technol. 171, 134 (2002).

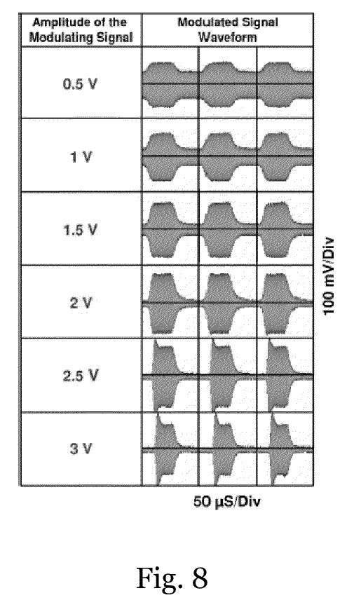

To generate the UHF plasma, the UHF signal may be modulated using a square wave with a duty cycle, before amplification, at the frequencies of 5 KHz, 10 KHz, 20 KHz, and 30 KHz. Referring to FIG. 8, the amplitude of the pulse may be varied from 0.5 to 3 Volts in 0.5 Volts increments. Both the input square wave and the modulated UHF signal may be monitored using a mixed signal oscilloscope. FIG. 8 demonstrates a waveform captured upon self ignition of each APAMP of the modulated UHF signal with a carrier frequency of about 740 MHz at the periodic pulse signal frequency of about 20 KHz for different pulse amplitudes. The waveform of the radiated RF from magnetic loop was similar to that from the signal generator.

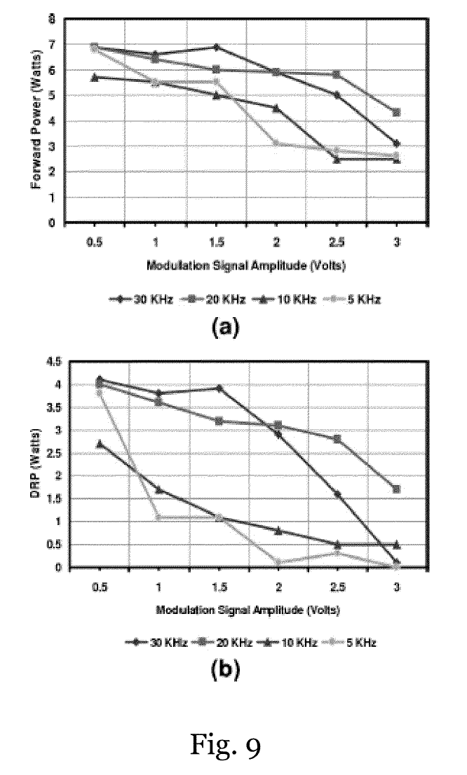

Referring to FIG. 9(a), the required power for self-ignition of the APAMP is plotted versus pulse amplitude at different modulating frequencies for a duty cycle of 50%. As can be seen, as the pulse amplitude is increased, the electric field produced by the applied peak voltage is enhanced, and thus the required power for self ignition is reduced. The residual electrons during the pulse off time may also reduce the power requirement for the plasma ignition at each cycle. Referring now to FIG. 9(b), the difference in required power (DRP) between the minimum forward power for plasma self ignition and operation is reduced as the pulse amplitude is increased. The increase in pulse amplitude not only decreases the required power for plasma ignition and operation, but also reduces the DRP. Thus, the minimum power required for operation and self ignition approach the same value. The decrease in duty cycle leads to reduced power consumption and greater discharge stability.

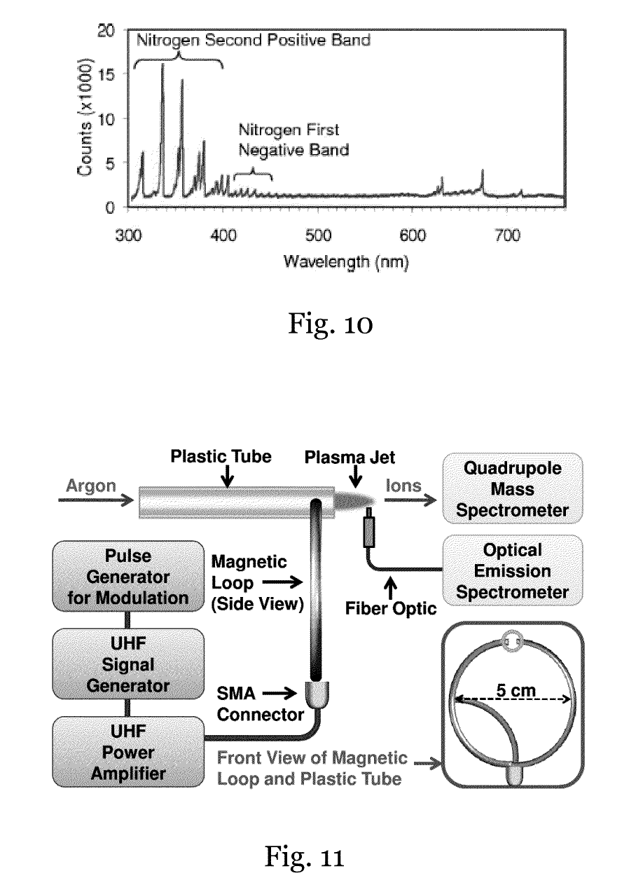

The optical emission spectra from the plasma may be monitored. A typical emission spectrum, representing time and spatially integrated emission intensities, is shown in FIG. 10. No change in spectrum was observed due to PM. However, the peak and continuum intensities were enhanced as the plasma operating power was increased. The observed spectra showed only molecular peaks.

### Generation of Plasma in Gas

In a second embodiment, a tube may be placed at the gap in the magnetic loop to generate plasma in gases such as argon, nitrogen and helium. Referring to the block diagram shown in FIG. 11, tin-coated copper may be used to construct the magnetic loop. The magnetic loop comprises a round structure having a diameter of 5 cm and an inner arc. In one aspect of this invention, the round structure of the magnetic loop has a gap having a 2.5 mm width. However, widths of other dimensions are also within the scope of this invention.

Still referring to FIG. 11, the loop may be connected to the ground shell of a connector capable of supplying the magnetic loop with RF power. The connector may be positioned at the intersection of the diagonal line passing the gap on the other side. Though the following discussion refers to a Sub-Miniature A (SMA) connector, any other type of connector capable of supplying the magnetic loop with RF power, including a Bayonet Neill-Concelman (BNC) connector and the like, is within the scope of this invention. The inner arc of the magnetic loop, as shown in FIG. 11, may be connected between the male pin of the SMA connector and one quarter of the loop's diameter away from the gap on the loop.

The 2.5 mm gap between the electrodes of the magnetic loop may be resided in a tube, preferably constructed from a plastic or glass material. In one embodiment, the tube has an inner diameter of 5 mm and an outer diameter of 8 mm. Preferably, the distance between the electrodes and the end of the plastic tube is approximately 4 mm. Still referring to FIG. 11, a gas such as argon may be introduced into the tube. Preferably, the gas will be introduced at a rate of 0.8 L/min using a mass flow meter. The UHF sinusoidal signal at about 850 MHz, corresponding to the resonance frequency of magnetic loop, may be supplied by the UHF signal generator and amplified by the UHF amplifier to the magnetic loop through the SMA connector.

### Network Analysis

The circumference of the magnetic loop (approximately 15.5 cm) corresponds to half-wavelength of the UHF sinusoidal signal. The resonance frequency of the magnetic loop is at approximately 960 MHz. With the plasma jet ignited, the resonance frequency of the loop may be determined by sweeping the UHF signal frequency while monitoring the plasma jet power and emission intensity. The maximum plasma emission intensity and forward power (minimum reflected power) occurs at the frequency of approximately 850 MHz. Thus, formation of the plasma jet changes the overall impedance of the circuit and results in a shift of the resonance frequency by about −110 MHz.

As discussed above, the plasma jet may not be self-igniting and the ignition techniques discussed above may need to be used. Upon ignition, a stable and self sustaining plasma jet is formed between electrodes and expanded to open air. The forward and reflected plasma powers were about 9 Watts and about 3 Watts, respectively. However, the power efficiency may be improved via an impedance matching network or a dual stub tuner.

### Optical Emission Spectroscopy of the Plasma Jet

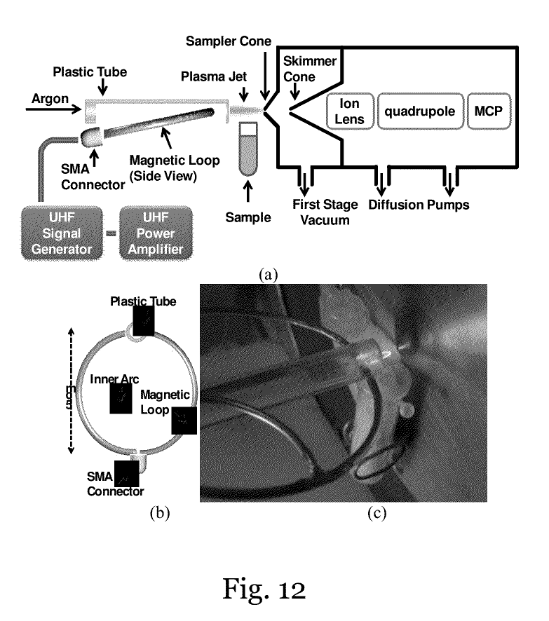

A hand-held spectrometer may be used to obtain the emission spectra of the plasma jet. Although the emission spectra will be obtained between the wavelengths of 300 to 760 nm, lower and higher wavelengths ranges may be used by using other optical emission spectrometers. Sample vials of a 2.0 mL microcentrifuge tube are preferably positioned 1 cm below the plasma jet, to allow ionization of the sample vapor, as shown in FIG. 12(a) and FIG. 12(c). However, smaller vials and even a capillary(ies) may be used, especially when the sample is limited, or is toxic, or expensive. The interaction of the plasma jet with the sampler cone of the mass spectrometer is shown in FIG. 12(c).

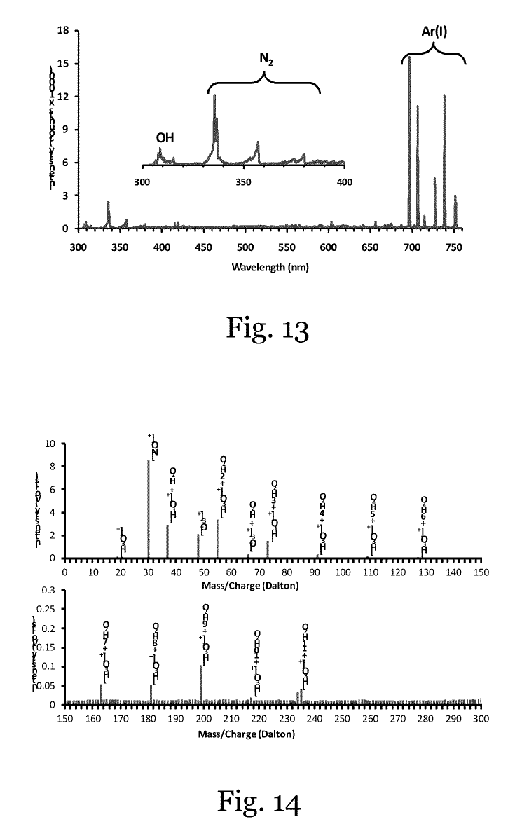

The emission spectrum of the plasma jet is shown in FIG. 13. The dominant atomic emission peaks were argon lines at the wavelengths of about 696.5, 706.7, 714.7, 727.3, 738.4, 750.4, and 751.5 mm Weak molecular band of nitrogen and water (OH) were also present in the emission spectrum.

### Mass Spectrometry

The background mass spectrum of the plasma jet is shown in FIG. 14. The dominant peaks were NO⁺, O₃⁺, and protonated water cluster ions. Hydrated ozone was also detected at m/z of 66. The observed ozone ion and its hydrated form were in accordance with the smell of the ozone gas due to plasma operation. The low proton affinity of H₃O⁺ among the protonated water clusters resulted in relatively smaller peak for H₃O⁺. The observed peaks in the background spectrum of the plasma jet were also present in the mass spectra after sample introduction.

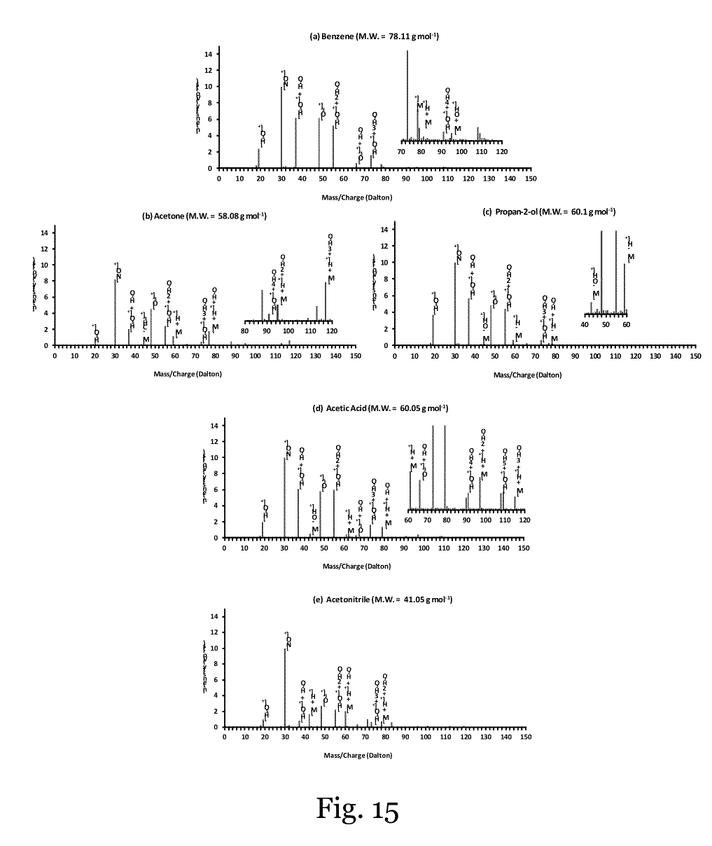

Volatile organic compounds with different functional groups were introduced into the plasma to obtain the mass spectra for the compounds (a) benzene, (b) acetone, (c) propan-2-ol, (d) acetic acid, (e) acetonitrile as shown in FIGS. 15(a)-(e). In FIG. 14, the letter M denotes the intact organic molecular ion.

In the case of benzene, as shown in FIG. 15(a), the major peak of the benzene was the molecular ion of benzene at m/z of 78. This ion results from collision of benzene molecule with an electron to produce a singly charged benzene molecule. The other benzene related peaks present in the spectra were [M+H]⁺ and [M+OH]⁺, at m/z of 79 and 95, respectively. For acetone, as shown in FIG. 15(b), [M+H]⁺, [M+H]⁺+H₂O, [M+H]⁺+2H₂O, and [M+H]⁺+3H₂O were the dominant peaks corresponding to the protonated acetone and water clusters containing acetone ions. For the acetone molecule, fragmentation also led to the loss of alkyl groups resulting in a small fragment of [M−CH₃]⁺ at m/z of 43. The major species observed for propan-2-ol, as shown in FIG. 15(c), were [M−H]⁺, [M−H]⁺+H₂O, and [M−OH]⁺ in the order of abundance. The formation of [M−OH]⁺ was favorable because of secondary carbonation formation as a product. As shown in FIG. 15(d), the major peaks detected for acetic acid were [M+H]⁺+H₂O, [M−OH]⁺, [M+H]⁺, [M+H]⁺+2H₂O, and [M+H]⁺+3H₂O. Formation of [M−OH]⁺ is due to detachment of the OH bond from the carbonyl carbon. Analysis of acetonitrile resulted in detection of [M+H]⁺+H₂O, [M+H]⁺, and [M+H]⁺+2H₂O in the mass spectrum, as shown in FIG. 15(e).

All of the organic compounds used in this study produced the [M−H]⁺ or [M+H]⁺. In addition, production of hydrated ions was observed for all samples. However, fragmentation was only observed for acetone, propan-2-ol, and acetic acid. For these molecules, loss of OH and CH₃ groups is well recognized during ionization.

### Applications and Characteristics of Plasma Jet

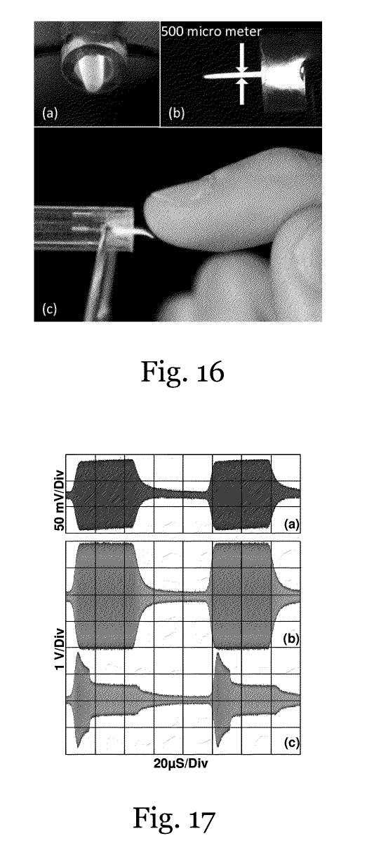

Referring to FIG. 16(a), the system described above for generating plasma in argon may be used to generate a self sustaining tongue-shaped plasma jet. As shown in FIGS. 16(a) and 16(b), in one aspect of the invention, the tongue-shaped plasma is approximately 2.5 mm wide, 10 mm long, and 0.5 mm thick. As shown in FIG. 16(c), the generated plasma jet is non-thermal and does not hurt human skin for exposure times as long as several minutes.

A charge coupled detector (CCD) camera with a micro lens may be used to capture photographs of the plasma jet at variable exposure times to investigate the propagation of the plasma jet in open air. Imaging is performed at an angle of 90 degrees with respect to the planar surface of the tongue-shaped plasma jet. Optical emission spectroscopy of the plasma jet is performed using a spectrometer between 300 nm to 760 nm at integration times of up to 500 ms. The reflection parameter of the magnetic loop with different gap width may be studied using a network analyzer. Positive ion mass spectrometric studies of the plasma jet may be performed using a Delsi-Nermag quadrupole instrument equipped with a Coniphot analogue detector operated at −650 volts and −550 volts. H. Zhang, S -H. Nam, M. Cai, and A. Montaser, Appl. Spectrosc. 50, 427 (1996); K. Jorabchi and A. Montaser, Spectrochim. Acta 59 B, 1471 (2004). Any other mass spectrometer may be used, including microfabricated mass spectrometers and miniature mass spectrometers such as those described by S. Pau, C. S. Pai, Y. L. Low, J. Moxom, P. T. A. Reilly, W. B. Whitten, and J. M. Ramsey, “Microfabricated Quadrupole Ion Trap for Mass Spectrometer Applications,” Phys. Rev. Lett., 96, 120801 (2006) or hand-held mass spectrometer described by Liang Gao, Qingyu Song, Garth E. Patterson, R. Graham Cooks, and Zheng Ouyan, “Handheld Rectilinear Ion Trap Mass Spectrometer”, Anal. Chem. 78, 5994-6002 (2006), or L. Gao, † R. G. Cooks, and Z. Ouyang, : “Breaking the Pumping Speed Barrier in Mass Spectrometry: Discontinuous Atmospheric Pressure Interface”, Anal. Chem. 80, 4026-4032 (2008), or A. Keil, N. Talaty, C. Janfelt, R. J. Noll, L. Gao, Z. Ouyang, and R. G. Cooks “Ambient Mass Spectrometry with a Handheld Mass Spectrometer at High Pressure”, Anal. Chem. 79, 7734-7739 (2008), or T. Evans-Nguyen, L. Becker, V. Doroshenkoc, R. J. Cotter, “Development of a Low Power, High Mass Range Mass Spectrometer for Mars Surface Analysis”, Inter. J. of Mass Spectro., 278, 170-177 (2008). For enhanced sensitivity in mass spectrometry, an ion funnel can be coupled to plasma as recently described by P. V. Johnson, R. Hodyss, K. Tang, W. B. Brinckerhoff, and, R. D. Smith, “The Laser Ablation Ion Funnel: Sampling for In-Situ Mass Spectrometry on Mars” Planetary and Space Science 59 387-393 (2011).

### Resonance Frequency of the Magnetic Loop Device

The effect of resonance frequency of the magnetic loop as a function of gap width is shown in FIG. 3. By increasing the gap width from 1 to 4 mm, the resonance frequency of the magnetic loop shifted from about 920 MHz to about 970 MHz. In our experiments, the magnetic loop gap was 2.5 mm. For magnetic loop gap of 2.5 mm the resonance frequency was about 960 MHz. The resonance frequency, during plasma jet operation, may be determined by sweeping the UHF signal frequency while monitoring the plasma jet power and optical emission intensity.

### Power Consumption

Three major factors affect power consumption in plasmas generated with a magnetic loop device: 1) electromagnetic radiation, 2) the consumed power in plasma jet, and 3) Ohmic heating in the connectors, the cable, and the magnetic loop.

The modulated sinusoidal signal from a UHF signal generator was supplied to the UHF power amplifier. The power output of the UHF power amplifier changed during the measurements based on operating conditions, such as modulation frequency. The radiated signal waveforms, captured using an antenna probe, were monitored using an RF power meter and an oscilloscope.

With an operating plasma jet, the radiated forward and reflected powers were measured at about 850 MHz for modulation frequencies of about 10 KHz to about 100 KHz in 10 KHz increments. The plasma jet was then switched off, by blocking argon flow, to measure the radiated, forward, and reflected powers.

Referring to FIG. 26, the captured radiated power from the magnetic loop device is about 2 to 14 times greater without the plasma than with the plasma, depending on the modulation frequency. The signal output from the signal generator, radiated signal without plasma and with the plasma is shown in FIG. 17. The radiated signal was reduced after formation of the plasma.

With no plasma, it can be assumed that the Ohmic heating was negligible and the total power was consumed as radiation. The following formula may be used to calculate the radiated power when the plasma jet is on:

$$\frac{{( Net Radiated Power )}_{Plasma on}}{{( Antenna Probe Power )}_{Plasma on}} = \frac{{( Net Radiated Power )}_{Plasma off}}{{( Antenna Probe Power )}_{Plasma off}}$$

The plasma power may then be calculated using the following relation: Plasma Power=(Net Radiated Power)_{Plasma off}−(Net Radiated Power)_{Plasma on}

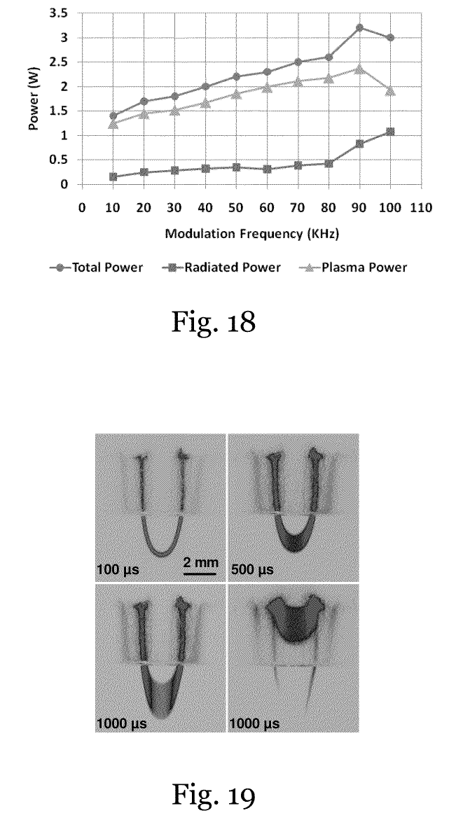

As shown in FIG. 18, the dissipated power in the plasma jet increased by increasing the modulation frequency. The power dissipation without pulse modulation was higher than that with pulse modulation.

### Plasma Jet Propagation

Fast photography of plasma jet may be used to reveal the dynamic behavior for a single

U-shaped plasma between two electrodes. The camera is synchronized with pulse modulated signal. Referring to FIG. 19, the plasma moves back forth, generating a tongue-shaped plasma jet. Photographs of the plasma jet are presented in FIG. 19 at exposure times of 100, 500, 1000 μs. The laminar velocity of argon flowing through the plasma tube is approximately 2 m/s at the flow of 1.2 L/min. The U-shaped plasma axial velocity is approximately 30 m/s. Therefore, the U-shaped plasma travels approximately 15 times faster than plasma gas. The U-shaped plasma appears to move in a periodic fashion. However, this movement exhibits no dependency on the modulation frequency.

### Effects of Pulse Modulation on Jet Shape and Length

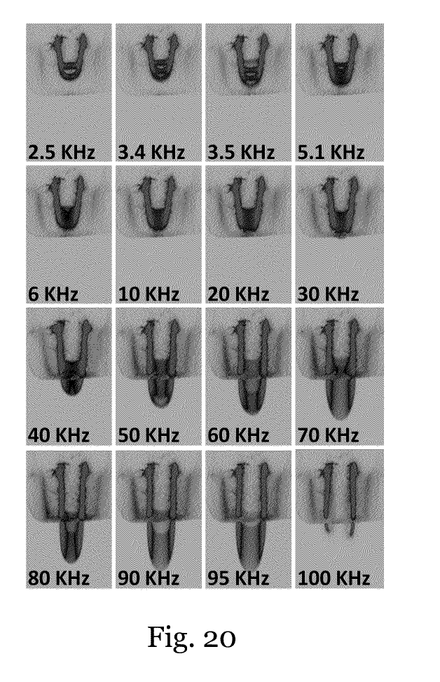

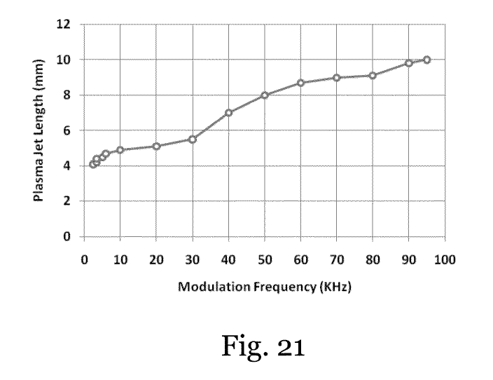

Referring to FIG. 20, when the plasma jet is sustained at the carrier frequency of about 850 MHz using pulse modulation frequency ranging from about 2.5 KHz to about 100 KHz, different plasma jet geometries may be observed depending on the modulation frequency. For greater clarity, the color was modified using DaVis software (LaVision Inc). At a modulation frequency of about 2.5 KHz, the plasma consists of two U-shaped plasma arcs with static location. By increasing the modulation frequency, the number of U-shaped plasma arc may be increased and the plasma jet may be expanded into the open air up to 1 cm. For modulation frequencies more than about 95 KHz, the tongue-shaped plasma jet separates in the middle and a horn-shaped plasma plume forms at the end of each electrode with a small tilt towards the middle of the plasma tube. With no modulation, the application of a UHF signal at about 850 MHz results in the formation of only one U-shaped plasma arc between electrodes. By reducing the power, the same plasma jet geometry may be observed at modulation frequencies greater than about 95 KHz. The plasma length was dependent on the modulation frequency. As shown in FIG. 21, plasma length may be increased from 4 mm to 10 mm as the modulation frequency is increased from about 2.5 KHz to about 100 KHz.

### Mass Spectrometric Studies

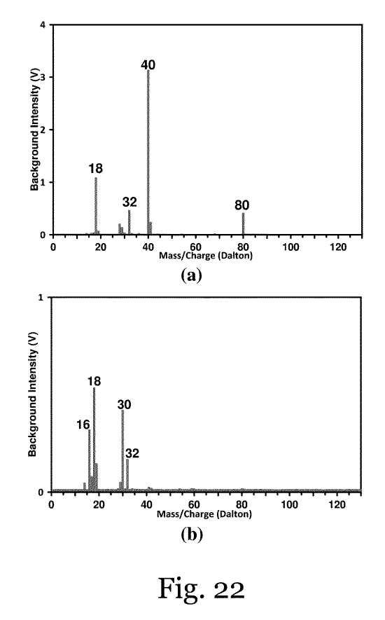

Characterization of plasma jets by mass spectrometry is important for providing information regarding the types and the concentration of ionic plasma species available for treating biological materials. J. A. Rees, D. L. Seymour, C. Greenwood, Y. A. Gonzalvo, D. T. Lundie, Plasma Process. Polym. 7, 92 (2010). Mass spectrometric studies were performed in positive ion mode under two plasma sampling conditions. In the first condition, a nitrile rubber disc, with a ˜100-μm orifice was placed on top of the 0.6 mm aluminum sampler orifice of the mass spectrometer, bringing the sampling flow rate close to the plasma gas flow rate to minimize ambient air sampling. For this experiment, the detector voltage was set at −650 V. As shown in FIG. 22(a) the detected ions consisted of Ar⁺, H₂O⁺, O₂⁺, Ar₂⁺, ArH⁺, N₂⁺, and N₂H⁺ in the order of relative abundance. Non-argon ions are attributed to air entrainment and ionization of ambient air components by Ar⁺ ions via collisions during transport from atmospheric pressure to the first vacuum stage of the mass spectrometer (2 Torr).

For the second sampling condition, the original 0.6 mm orifice may be used without the nitrile rubber disc, leading to oversampling of ambient air, thereby promoting ion-molecule interactions in the first vacuum stage (10 Torr). As a result, as shown in FIG. 22(b), certain high-energy ions (such as N₂³⁰ , Ar⁺) disappeared from the spectrum. Further, several ionic species (such as H₂O⁺, NO⁺, O⁺, O₂⁺, H₃O⁺) exhibited increased intensities. The other ionic species detected at lower concentration included OH⁺, N⁺, and N₂H⁺. These results show that the extent of the plasma interaction with air affects the types of ions produced and their intensities. Thus, experimental conditions should be controlled in plasma treatment of biological materials.

### Optical Emission Spectroscopic Studies

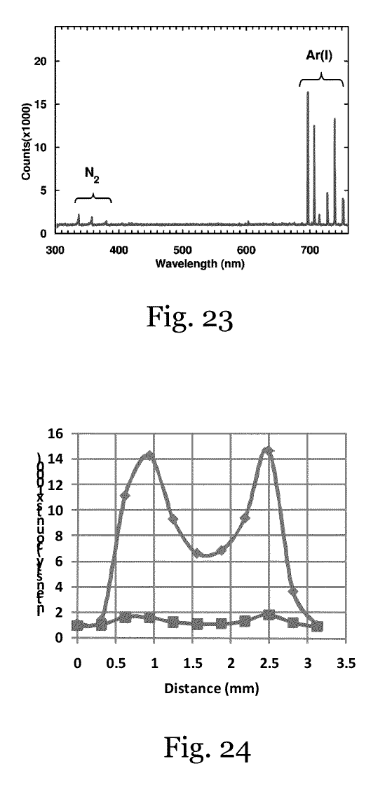

An optical emission spectrum of the argon plasma jet was recorded between 300 and 760 nm. A hand-held optical spectrometer may be used to identify the major emitting species that may play a role in the treatment of biological materials. To obtain the emission spectrum shown in FIG. 23, the plasma tip was observed laterally, with the spectrometer fiber optics (200 wn diameter) placed 3 nim from the plasma. The UHF plasma jet is observed to be more intense than the counterpart high-voltage, pulsed DC plasmas. The dominant peaks are attributed to argon atomic emission at wavelengths 696.5, 706.7, 714.7, 727.3, 738.4, 750.4, and 751.5 nm. A nitrogen molecular band is also observed at low intensities between 330 and 380 nm. The results for the argon plasma jet markedly differ from the emission spectrum for the air plasma formed in a similar magnetic loop because the spectrum for the air plasma showed only molecular peaks.

The emission profiles of nitrogen and argon at wavelengths of 337 and 697 nm, respectively, is shown in FIG. 24 for the plasma jet. The plasma is more intense in the arc regions compared to the discharge center.

### Treatment of Onion Epidermal Membrane

The mechanism of interaction between non-thermal plasmas and biological systems is not fully understood. M. Laroussi, Plasma Process. Polym. 2, 391 (2005). The sterilization effect in plasma treatment is believed to originate from interaction of ions and bacteria, resulting in the damage to the bacteria structure to or bacteria destruction. However, atmospheric-pressure cold-plasmas, similar to the plasma investigated in this work, do not produce appreciable dose of optical emission to have a pronounced effect on sterilization.

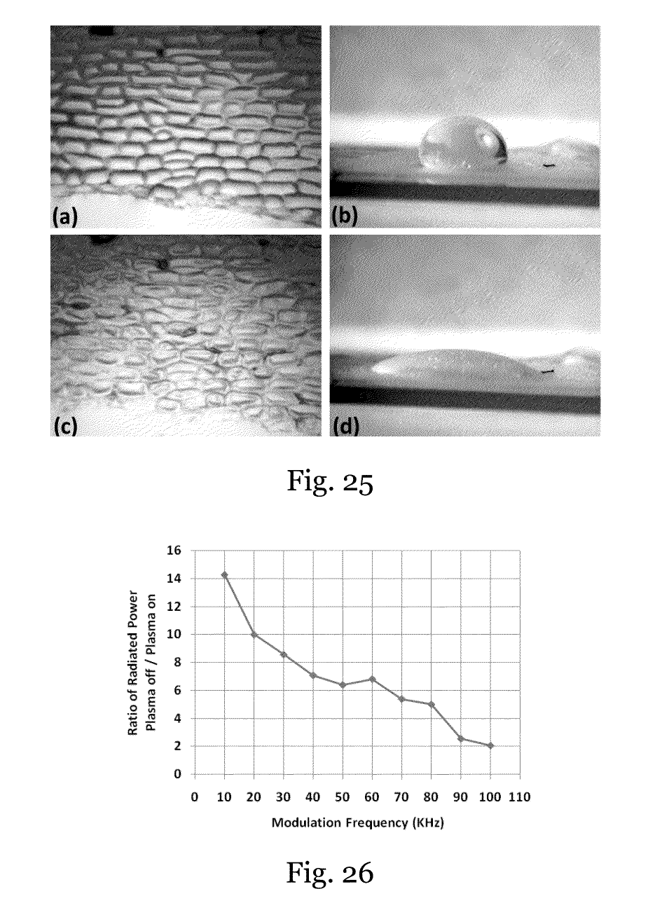

Effects of the plasma jet of the present invention were investigated on cellular structure and hydrophobicity of the membrane before and after plasma treatment. Though experiments were performed on the epidermal membrane from fresh onions, this invention is in no way limited to such onion membranes or the magnetic loop configuration shown in FIG. 7. Thus, the plasmas generated as described herein may be used for treatment of animal skin (e.g., human skin) and the like. An onion epidermal cell is nearly rectangular in shape and contains a spherical nucleus. To avoid dehydration at room temperature, the membrane was placed on a water-coated glass slide, with the inner side of the cell layer facing up. The membrane was then exposed to the plasma jet. During treatment, the plasma was repelled from the membrane surface, creating a gap or a boundary layer of less than 0.5 mm. Consequently, the plasma did not arc to the membrane surface. This behavior differs from that of other plasmas that visibly touch the surface. Referring to FIGS. 25(a) and 25(c), respectively, shapes of epidermal cells before and after plasma treatment for 1 minute are shown. While the contours of cells were slightly altered after treatment, the membrane structure was minimally affected. 100981 Plasma treatment, however, resulted in a change in hydrophobicity of the onion membrane. This change may be demonstrated referring to FIGS. 25(b) and 25(d). Referring to FIG. 25(b), a drop of water is shown placed on the membrane before plasma treatment. Similarly, as shown in FIG. 25(d), a drop of water was also placed on the membrane after plasma treatment. The hydrophobic epidermal layer showed hydrophilic properties after plasma treatment.

Several factors (such as heat, ultraviolet (UV) radiation, argon gas flow, UHF radiation, and reactive species and ions) can affect hydrophobicity of the onion membrane. To separately study the effects of these parameters, four epidermal membranes were placed on water-coated slides. With no plasma present, each membrane were separately exposed to either heat (from a heater), or UV radiation (from a mercury lamp), or argon gas flow (1.2 L/min), or the UHF radiation (from magnetic loop at about 4.2 Watts). The membrane hydrophobicity was not affected by each of the cited factors. Thus, the change in membrane hydrophobicity is likely caused through interaction with reactive species and ions from the plasma.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An apparatus for generating a non-thermal, ultra-high frequency plasma at atmospheric pressure, the apparatus comprising:
a magnetic loop having a first end, a second end and a gap of a predetermined width between the first and second ends, the magnetic loop generating the non-thermal, ultra-high frequency plasma at atmospheric pressure in the gap of the magnetic loop;
an inner arc connected to the magnetic loop; and
a connector for supplying the magnetic loop with RF power.

2. The apparatus of claim 1, wherein the plasma is self-igniting.

3. The apparatus of claim 1, wherein the first end and the second end of the magnetic loop are positioned within a tube for directing the flow of gas to the first and second ends to form a plasma jet.

4. The apparatus of claim 3, wherein the plasma is ignited by short circuiting the first end and the second end.

5. The apparatus of claim 4, wherein the magnetic loop resonance frequency shifts due to plasma jet formation.

6. The apparatus of claim 3, wherein the plasma is formed in the UHF frequency range.

7. The apparatus of claim 1, wherein increasing the width of the gap increases a resonance frequency of the magnetic loop for plasma generation.

8. A method of generating a non-thermal ultra-high frequency plasma, the method comprising:
receiving an amplified ultra high frequency signal by a magnetic loop, the magnetic loop comprising a conductor having a first end, a second end and a gap between the first and second ends and an inner arc; and
generating the non-thermal, ultra-high frequency plasma in the gap of the magnetic loop.

9. The method of claim 8, wherein the plasma is generated in air.

10. The method of claim 9, wherein the plasma is self-igniting.

11. The method of claim 8, wherein the generated plasma is suitable for interaction with animal skin.

12. The method of claim 8, further comprising:
positioning the first end and the second end in a tube for directing gas flow to the first end and second end for plasma formation; and
supplying an inert gas through the tube.

13. The method of claim 12, wherein the plasma is generated in the inert gas.

14. The method of claim 13, wherein the plasma is generated in the inert gas by short circuiting the first end and the second end.

15. The method of claim 13, wherein the plasma is generated by introducing a second plasma to the first and second ends.

16. The method of claim 13, wherein a frequency at which plasma is generated varies based at least in part on a size of the magnetic loop and a width of the gap.

17. The method of claim 13, wherein the inert gas is argon.
